(19) United States
(12) Patent Application Publication
(10) Pub. No.: US 2013/0242101 A1
(43) Pub. Date: Sep. 19, 2013

(54) Method and Device for Representing Obstacles in a Parking Assistance System of Motor Vehicles

(71) Applicants: Marcus Schneider, Ludwigsburg (DE); Volker Niemz, Rutesheim (DE)

(72) Inventors: Marcus Schneider, Ludwigsburg (DE); Volker Niemz, Rutesheim (DE)

(73) Assignee: Robert Bosch GmbH, Stuttgart (DE)

(21) Appl. No.: 13/816,271

(22) PCT Filed: Aug. 13, 2010
(86) PCT No.: PCT/EP2010/061849

§ 371 Date: Feb. 11, 2013

(30) Foreign Application Priority Data
Sep. 14, 2009 (DE) 10 2009 029 439.2

(51) Int. Cl. G06K 9/00; H04N 7/18

(52) U.S. Cl. CPC G06K 9/00805; H04N 7/18
USPC 348/148; 382/104

(57) ABSTRACT

A method for representing obstacles in a parking system of motor vehicles is disclosed. The method includes the following steps: a) determining an image of the surroundings and detecting obstacles located therein, b) determining at least one distance value and/or one angular position of the detected obstacles, c) applying an edge reinforcing method to regions of the image of the surroundings depending on the determined distance values and/or angular positions, and d) displaying the edge reinforcement with the determined image of the surroundings in a display of the parking assistance system. A device for carrying out the method is also disclosed.

### PRIOR ART

Parking assistance systems in various embodiments and with different display concepts for assisting the driver during parking processes have been known for a long time. They can be divided substantially into two classes, specifically the systems which are based on distance measurements such as, for example by means of ultrasound or radar sensors, and the video-based systems. The systems which are based on distance measurement usually provide the driver with an acoustic, for example short warning tones with a distance-dependent repetition frequency, and/or optical warning such as, for example, by means of LED lines with a distance-dependent number of switched-on LEDs. In contrast, video-based systems comprise, for example, a reversing camera, and the video camera captures the situation in the region around the rear bumper, with the result that the corresponding image can be output on a screen in the driver's field of vision. If appropriate, the video image is previously equalized in order to present the driver with an image of the surroundings which is as realistic as possible.

Recently, combined systems have also become widespread. In this context, for example distance bars for indicating the distance measured values of the ultrasound system are included in the displayed video image.

The disadvantage of video-based systems is that they require the driver's complete attention, specifically in situations in which the image contains only inadequate features for estimating the size and the distance. The inclusion of distance bars also reduces this problem only to a slight degree since in this case two different classes of information, the real objects and the graphically simplified artificial objects, have to be perceived, and processed simultaneously by the driver. The additional acoustic warning in such a combined system also prevents simplified perception by the driver because further information also has to be processed here.

A further example of a combined system for assisting the driver of a motor vehicle when parking is known from DE 10 2007 002 262 A1. In addition to distance-determining sensors, at least one camera is integrated into the system. The system permits a graphic representation of a parking space including the various boundaries, and the driver can use input keys to optimize the target position of his own vehicle according to his wishes and to adapt said position to the conditions which he has perceived himself. In this context, DE 10 2007 002 262 A1 has likewise disclosed detecting various boundaries and classifying them, with the result that the boundaries are represented according to various classes. For example, planters, plants, walls and the like can be displayed differently so that the driver can relativize some obstacles as pliable or movable, and therefore parking in parking spaces which the system in itself would have not considered is made possible. As optical assistance, the parking space and its boundaries and/or the driver's own vehicle can be represented partially transparently in order to be able to determine.

However, this system does not achieve simplified perception of the actual surroundings by the driver, in particular with respect to obstacles which are located near to the vehicle as opposed to obstacles which are further away.

### DISCLOSURE OF THE INVENTION

The method according to the invention as claimed in claim 1, which can be carried out with the device as claimed in claim 6, which is also according to the invention, has, compared to the prior art, the advantage that it enables the driver to detect, with a single glance on the display of the parking assistance system, the relevance of obstacles in terms of their distance, and to understand said relevance. In addition, as a result of the edge reinforcement of the near obstacles it is also suitable for reliable use even without additional graphic and/or acoustic components. In this way, the driver is relieved since he does not have to perceive different display elements or various types of information simultaneously.

Furthermore it is advantageous that the method both reduces the complexity of the display or of the warning element as well as, in particular, limits to a minimum, by virtue of a simple design, the number and type of the components required. As a result, the method of the present invention can both be produced cost-effectively and also inform the driver in an optimum way without confusing the driver as a result of too many different types of items of information.

Accordingly, the subject matter of the present invention is a method for representing obstacles in a parking assistance system of motor vehicles, comprising the following steps:
a) determining an image of the surroundings and detecting obstacles located therein,
b) determining at least one distance value and/or one angular position of the detected obstacles,
c) applying an edge reinforcing method to regions of the image of the surroundings as a function of the determined distance values and/or angular positions, and
d) displaying the edge reinforcement with the determined image of the surroundings in a display of the parking assistance system.

The distance-conditioned relevance of individual obstacles can be more easily perceived by the driver on the basis of the edge reinforcement according to the invention, as a result of which the driver's attention can be directed at the relevant obstacles. By means of the method according to the invention, an excess of graphic information is therefore filtered and displayed in a way which is optimized to the driver's requirements with respect to the parking situation.

For example graphics-processing mathematical software systems based on edge filters and/or edge operators such as, for example, Sobel, Laplace, Canny algorithm, Kirsch operator and the like are, for example, suitable as edge-reinforcing methods within the sense of the present invention. In particular, such systems which are based on the absolute value of the gradients, with the result that what are referred to as gradient ranges are produced in the region of the edge, are suitable for carrying out the edge reinforcement.

As a result of subsequent contour detection methods such as, for example, the Freeman code, contour accumulations can then be grouped to form rudimentary objects, around which a bounding box can be placed.

Modern parking assistance systems already supply information on the distance from the obstacles and also on the direction of the obstacles, with the result that implementation in already existing hardware can take place.

Further advantages and advantageous refinements of the subject matter according to the invention can be found in the description, the drawings and the patent claims.

In one preferred refinement of the method according to the invention, the detected obstacles can be colored and/or animated as a function of the determined distance values and/or the angular position.

As a result, in addition, a clear relationship, which can be easily perceived by the driver, between the image region with the obstacle to be considered and the relevance of the obstacle can be formed and displayed.

It is also advantageous that obstacles which are determined as a function of the determined distance values and/or angular positions can be displayed with edge attenuation and/or out of focus.

In this way, with a brief glance the driver can understand which obstacles are actually relevant, without omitting the irrelevant obstacles completely.

In a further refinement of the method according to the invention, the edge reinforcement can be displayed more strongly the nearer the detected obstacle is located to the motor vehicle and/or the edge attenuation can be displayed more strongly the further the detected obstacle is located from the motor vehicle.

It is then advantageously possible to make available even more clearly for the driver a display which is ordered according to relevance and which does not require the driver to perceive and process additional information such as, for example, colored rectangles or bars. The system according to the invention is therefore very well suited even for drivers who are colorblind and/or have impaired hearing.

Alternatively or additionally, an entire region of the image of the surroundings can be displayed colored on the basis of the detected obstacle and as a function of the determined distance values and/or angular positions.

This serves to highlight the relevant obstacles and their image regions once more in contrast to the less relevant regions of the displayed image of the surroundings.

A further subject matter of the present invention is a device for representing obstacles in a parking assistance system of motor vehicles, comprising
at least one camera for determining an image of the surroundings,
means for detecting obstacles in the image of the surroundings,
means for determining distance values and/or angular positions of detected obstacles,
means for carrying out edge reinforcement with respect to the regions of the image of the surroundings containing obstacles or parts of obstacles, and
a display for representing the image of the surroundings with the edge reinforcement.

Inter alia, the means for detecting obstacles in the image of the surroundings can be software-based.

As already stated above, in addition to the at least one camera it is also possible to provide sensors such as, for example, ultrasound sensors for determining distance values and/or angular positions of the obstacles.

The means for carrying out edge reinforcement are preferably also software-based mathematical algorithms which can preferably be integrated, according to the invention, into a central control unit or into media control devices which are customary in motor vehicles.

The display for representing the image of the surroundings can be a display which is customary in motor vehicles, such as is also used for integrated navigation. By superimposing the image of the surroundings of the camera on the edge reinforcement which the control device has determined, clear and quickly perceptible information about the relevance of obstacles can be made available for the driver.

In a preferred embodiment of the device according to the invention, the means for determining distance values and/or angular positions can be ultrasound or radar sensors.

In this way it is possible to determine the required data on the distance values for the obstacles and/or the angular positions thereof in a way which is robust, reliable and cost-effective to manufacture.

In a further advantageous embodiment of the device according to the invention, the means for detecting obstacles and/or means for carrying out edge reinforcement can be integrated in a control device.

The camera can preferably have an angle of aperture which is matched to the means for detecting obstacles. As a result, an optimized observation range can easily be defined.

In a further preferred refinement of the device according to the invention, the camera can generate the image of the surroundings in the form of a digital signal. As a result, both the detection of the obstacles and the edge reinforcement are made possible by software-based systems.

### DRAWINGS

The invention will be explained in more detail below by means of preferred exemplary embodiments and with reference to the appended drawings, in which:

FIG. 1 is a schematic plan view of a parking assistance system in an embodiment according to the present invention, and

FIG. 2 shows an exemplary contrast of the functional principle of the method according to the invention (on the right) with the conventional view (on the left).

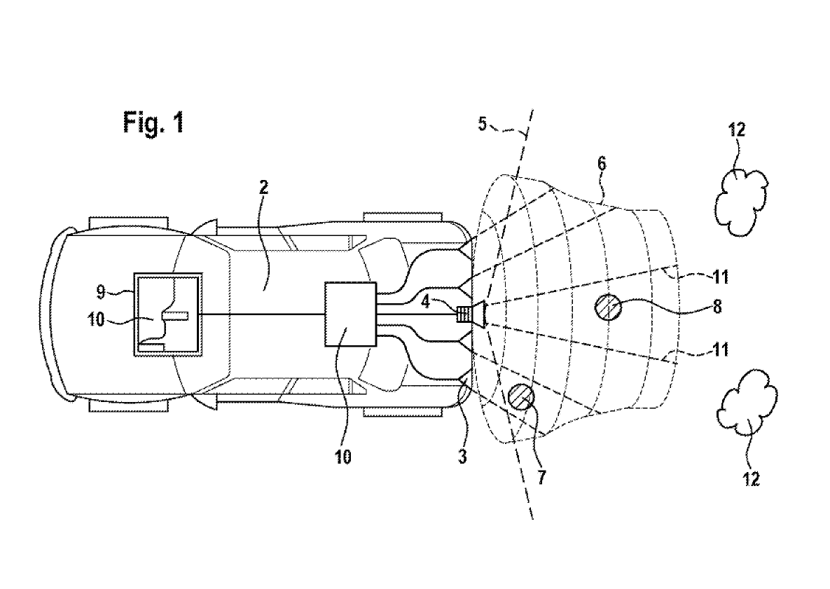

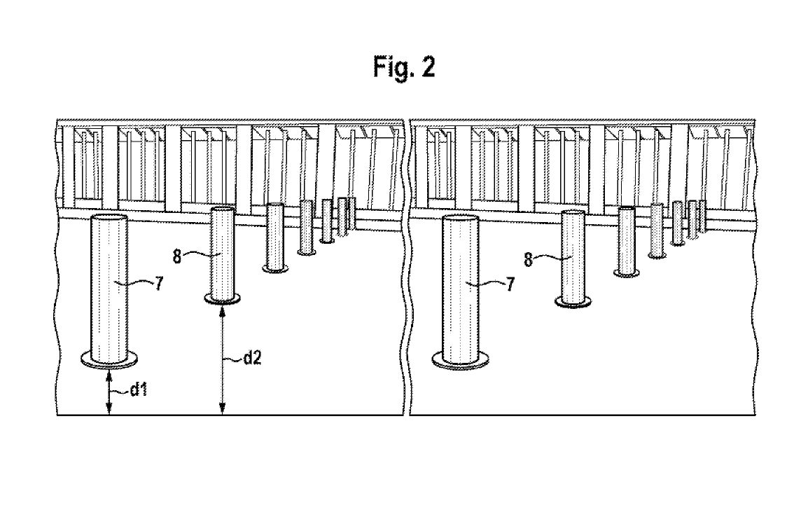

FIG. 1 illustrates schematically a parking assistance system 1 according to the present invention. On the one hand, a plurality of ultrasound sensors 3 which are installed in the rear of the vehicle, and on the other hand, a video camera 4 with the angle of aperture 5 for capturing an image of the surroundings, are connected to a control device 10 in a vehicle 2. The ultrasound sensors cover an ultrasound detection range 6 whose main component is captured by the video camera 4. Within the detection range 6 there are, in the given example, a plurality of objects or obstacles 7 and 8 which represent, for example, posts. Outside the detection range 6 there are only actually a plurality of objects 12. These are only actually captured by the camera 4 with the angle of aperture 5. The detection field 6 of the ultrasound sensors is divided into a plurality of direction zones 11 with defined sensor angles of aperture which are sensed by the ultrasound sensors 3, and are assigned in the control unit 10 to the individual zones 11 by means of suitable evaluation algorithms such as, for example, trilateration. Each zone 11 is assigned an image region in the image 20 of the surroundings (cf. FIG. 2). The image 20 of the surroundings is geometrically manipulated in accordance with the captured objects 7 and 8 by the control device 10 (cf. FIG. 2) and the result is output on the screen 9.

FIG. 2 illustrates an exemplary contrast of the functional principle of the method according to the invention, which is illustrated on the right with the contour-reinforced display view, and of the original image of the surroundings illustrated on the left. The camera (not illustrated here) captures the surroundings behind the vehicle and generates an image of the surroundings which can be evaluated digitally. At the same time, the ultrasound sensors (not illustrated here) senses a plurality of objects 7 and 8 and determine the respective angle and the distances d1 and d2 with respect to the objects 7 and 8. According to an assumption in this example, the object 8 lies outside the application case of the presented algorithm. The image columns in the given example are then edge-reinforced and an object is formed on the basis of the resulting contour. The corresponding edge-reinforced object is represented superimposed in the right-hand image.

1. A method for representing obstacles in a parking assistance system of motor vehicles, comprising:
a) determining an image of surroundings and detecting obstacles located therein,
b) determining at least one distance value and/or one angular position of the detected obstacles,
c) applying an edge reinforcing method to regions of the image of the surroundings as a function of the determined distance values and/or angular positions, and
d) displaying the edge reinforcement with the determined image of the surroundings in a display of the parking assistance system.

2. The method as claimed in claim 1, wherein the detected obstacles are colored and/or animated as a function of the determined distance values and/or the angular position.

3. The method as claimed in claim 1, wherein obstacles which are determined as a function of the determined distance values and/or angular positions are displayed with edge attenuation and/or out of focus.

4. The method as claimed in claim 1, wherein the edge reinforcement is displayed more strongly the nearer the detected obstacle is located to the motor vehicle and/or the edge attenuation is displayed more strongly the further the detected obstacle is located from the motor vehicle.

5. The method as claimed in claim 1, wherein an entire region of the image of the surroundings is displayed colored on the basis of the detected obstacle and as a function of the determined distance values and/or angular positions.

6. A device for representing obstacles in a parking assistance system of motor vehicles, comprising
at least one camera configured to determine an image of the surroundings,
means for detecting obstacles in the image of the surroundings,
means for determining distance values and/or angular positions of detected obstacles,
means for carrying out edge reinforcement with respect to the regions of the image of the surroundings containing obstacles or parts of obstacles, and
a display configured to represent the image of the surroundings with the edge reinforcement.

7. The device as claimed in claim 6, wherein the means for determining distance values and/or angular positions are ultrasound or radar sensors.

8. The device as claimed in claim 6, wherein the means for detecting obstacles and/or means for carrying out edge reinforcement are integrated in a control device.

9. The device as claimed in claim 6, wherein the camera has an angle of aperture which is matched to the means for detecting obstacles.

10. The device as claimed in claim 6, wherein the camera is configured to generate the image of the surroundings in the form of a digital signal.
